(19) United States
(12) Patent Application Publication
(10) Pub. No.: US 2011/0151291 A1
(43) Pub. Date: Jun. 23, 2011

(54) Battery Power Supply Having a Fluid Consuming Battery with an Improved Fluid Manager

(75) Inventors: Peter F. Hoffman, Avon, OH (US); Michael J. Brandon, II, North Rideville, OH (US)

(73) Assignee: EVEREADY BATTERY COMPANY, INC., St. Louis, MO (US)

(21) Appl. No.: 13/017,091

(22) Filed: Jan. 31, 2011

Related U.S. Application Data
(63) Continuation of application No. PCT/US09/04824, filed on Aug. 25, 2009.
(60) Provisional application No. 61/091,497, filed on Aug. 25, 2008.

(51) Int. Cl. H01M 2/00; H01M 10/00

(52) U.S. Cl. 429/50; 429/61

(57) ABSTRACT

A power source is provided for supplying electrical power to a device. The power source includes a fluid consuming battery comprising a fluid consuming electrode, the battery supplying a battery output power. The power source also includes a fluid manager for controlling the rate of fluid supplied to the fluid consuming battery, a communication link for receiving data defining device criteria for at least one device operating event, a power output for receiving the battery output power and supplying a power source output according to the device criteria, and a controller for controlling operation of the air manager based on the device criteria and a load. The device criteria for the device operating event includes at least one predetermined energy requirement estimate.

### CROSS-REFERENCE TO RELATED APPLICATIONS

This application is a continuation of International Application No. PCT/US2009/004824, filed Aug. 25, 2009, which claims the benefit of U.S. Provisional Application No. 61/091,497, filed Aug. 25, 2008.

### BACKGROUND OF THE INVENTION

The present invention generally relates to battery power supplies for supplying power to electrical devices and, more particularly, relates to a power source having a fluid consuming battery for supplying a controlled amount of power to one or more electrically powered devices.

Electrical powered devices, such as portable electronics including digital cameras, cell phones, flashlights, personal digital assistants (PDAs), PDA and smart phones, laptop computers, portable multimedia players and other portable electronic devices typically require one or more batteries, which supply electrical power to the device during normal operation. When the main batteries are rechargeable (secondary), an electronic device may include battery charging circuitry which provides electrical energy for charging the batteries. For many devices, the charging circuitry is typically powered from an alternating current (AC) power outlet or a 12 volt direct current (DC) power outlet, such as in an automobile. For some devices, an external auxiliary battery may be utilized with charge control circuitry to provide supplemental power to battery powered devices. The external auxiliary battery may operate to charge the internal battery in the device or may bypass the internal battery and provide electrical current to power the device.

It is desirable to provide for an advanced power source that may effectively and efficiently supply electrical power to electrical powered devices so as to charge and/or power the devices. It is further desirable to provide an auxiliary power supply that can include a high energy density battery using at least one material from outside the battery as an active material. Examples of such batteries include fuel cell batteries and metal-air batteries. It is also desirable to provide an auxiliary power supply that includes a high energy density battery using a gas from outside the battery as an active material and a fluid manager for controlling the rate at which the fluid enters the battery while minimizing the battery discharge capacity used to operate the fluid manager.

Previous attempts to control fluid managers of fluid consuming batteries such as fuel cells and metal air batteries have relied on opening, closing or adjusting valves or changing the operating speed of fans or pumps based on measured device and/or battery voltages, currents, loads, etc. Examples of such attempts are disclosed in U.S. Patent Publication Nos. 2006/0192523, 2007/0042245, 2007/0224461, 2006/0292405 and 2006/0208695 and in U.S. Pat. No. 6,106,962. A disadvantage of these methods of control is that they rely on electrical measurements that can change frequently, and they can result in more frequent operation or adjustments of valves, fans, etc., consuming more energy from the batteries than necessary.

There remains a need to more efficiently and effectively control the fluid managers for fluid consuming batteries to minimize the energy used to operate the fluid managers and extend the useful life of the fluid consuming batteries.

### SUMMARY OF THE INVENTION

According to one aspect of the present invention, a power source is provided for supplying electrical power to a device. The power source includes a fluid consuming battery comprising a fluid consuming electrode, said fluid consuming battery supplying a battery output power; a fluid manager for controlling a rate of fluid supplied to the fluid consuming battery; a communication link for receiving data defining device criteria for at least one device operating event; a power output for receiving the battery output power and supplying a power source output according to the device criteria; and a controller for controlling operation of the air manager based on the device criteria. The device criteria for the at least one device operating event include at least one predetermined energy requirement estimate.

According to another aspect of the present invention, the power source supplies electrical power for operating a device.

According to yet another aspect of the present invention, a method is provided for supplying electrical power to an electronic device. The method includes the steps of:

a. providing a fluid consuming battery including a fluid consuming electrode and a fluid manager;

b. coupling the fluid consuming battery to a device;

c. communicating data defining device criteria for at least one device operating event from the device to a controller associated with the fluid consuming battery for controlling a rate at which fluid is to be provided to the fluid consuming electrode, wherein the device criteria for the at least one device operating event include at least one predetermined energy requirement estimate;

d. determining an amount of energy to be provided to the device over a period of time based on the device criteria;

e. determining the rate at which fluid is to be provided to the fluid consuming electrode for the fluid consuming battery to provide the amount of energy to be provided over the period of time; and

f. controlling operation of the fluid manager to provide fluid to the fluid consuming electrode at the determined rate.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a block diagram illustrating an auxiliary coordinated power source connected to an external device for supplying electrical power to the external device, according to one embodiment;

FIG. 2 is a perspective view of the power source, according to one embodiment;

FIG. 3 is an exploded schematic diagram illustrating the auxiliary coordinated power source with a zinc air prismatic (ZAP) battery cell and air manager exploded therefrom, according to one embodiment;

FIG. 4 is a perspective view of the air manager, according to one embodiment;

FIGS. 5A and 5B are cross-sectional views taken through line V-V of FIG. 4 illustrating the air manager in the open and closed positions, respectively;

FIG. 6 is a flow diagram illustrating a method of supplying power to the external device with the coordinated power source, according to one embodiment;

FIG. 7 is a flow diagram illustrating an air manager control routine, according to one embodiment;

FIG. 8 is a state diagram illustrating state logic executed by control circuitry to control the valve, according to another embodiment; and

FIG. 9 is a circuit diagram illustrating power conversion circuitry coupled to the ZAP battery, according to one embodiment.

### DETAILED DESCRIPTION

The invention is exemplified below as an auxiliary power source including a fluid consuming battery that can be used to power an electronic device having another primary power source, such as alternating current or an internal battery, such as a rechargeable battery. However, the power source may also be a primary power source with a fluid consuming battery. The power source is coupled to the device but may be located in, on or separated from the device.

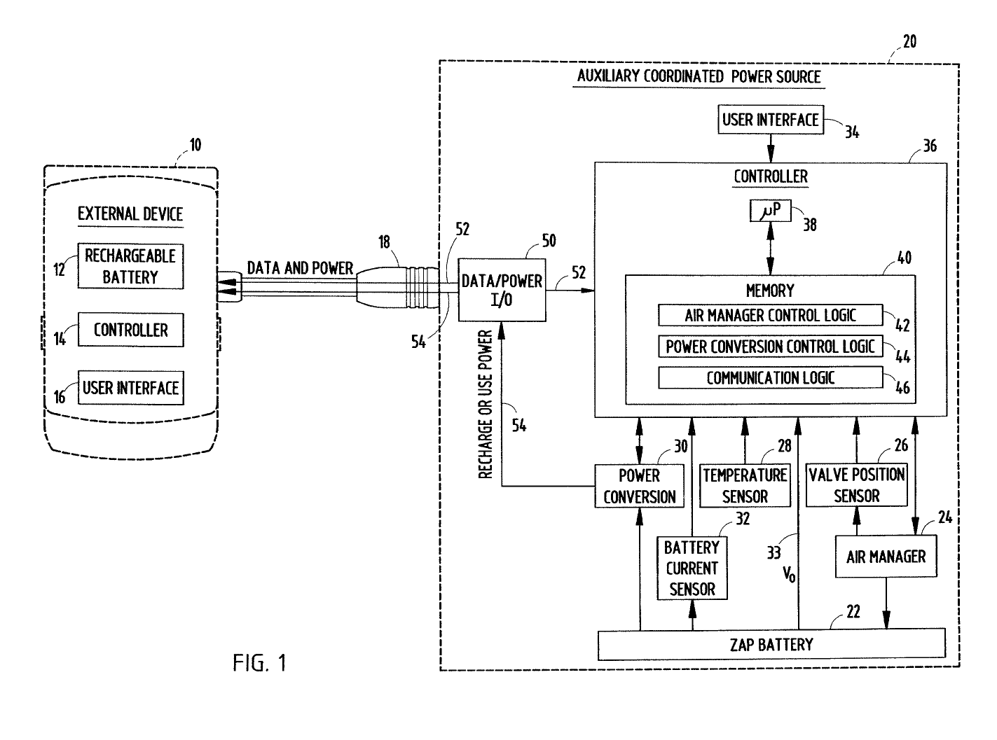

Referring to FIG. 1, a power source 20 is generally illustrated connected to an electrically powered device 10 for providing electrical power to the device 10. It should be appreciated that the power source 20 may operate as a sole source of power to the device or as an auxiliary power source. In an embodiment in which the device includes an internal rechargeable battery 12, the power source 20 can provide power to charge the internal rechargeable battery 12 in the device 10. According to another embodiment, the power source 20 may supply electrical power to power the device 10, bypassing the rechargeable battery 12. According to further embodiments, the device 10 may be powered by the power source 20 while the internal rechargeable battery 12 is undergoing recharging.

The device 10 is an electrically powered device that requires electrical power to operate to perform one or more tasks. The electrically powered device 10 may include any of a number of component electrical devices. Examples of the device 10 include a cell phone, a personal digital assistant (PDA), a PDA or smart phone, a music player (e.g., MP3, iPod, etc.), a laptop computer, a portable multimedia player, a game device, a camera, a radio, a bar code reader, a mouse or keyboard accessory, a lighting device and other electrical powered devices.

In the embodiment shown, the device 10 includes a rechargeable battery 12 which is shown provided inside of the device 10 to supply electrical power to operate the device 10. The rechargeable battery 12 may include a lithium ion battery, a nickel metal hydride (NiMH) battery, a nickel cadmium (NiCd) battery, a nickel zinc (NiZn) battery, or other storage elements such as electrochemical capacitors (e.g., ultracaps) according to various embodiments. It should be appreciated that the device 10 may include one or a plurality of rechargeable batteries of various types and sizes. The rechargeable battery 12 can supply energy for basic operation of the device 10 and can have a state of charge (SOC) indicative of the current charge capacity and requires generally periodic recharging depending on the state of charge.

The device 10 can also include a controller 14 which may include a microprocessor or other control circuitry as should be evident to those in the art. The controller 14 may receive and send data, monitor status of the rechargeable battery 12, control charging of the rechargeable battery 12, and provide programmed functionality to the device 10, such as performing phone and PDA tasks. The device 10 can also include a user interface 16, which may include a display, such as a touch screen display, a keyboard, push buttons or any other known user interface.

The power source 20 is shown connected to the device 10 by way of a data and power communication link such as connector 18. Connector 18 can provide both the transmission of power from the power source 20 to the device 10 on power line 54 and a bidirectional data communication path that allows data to be transmitted between the power source 20 and device 10 on communication line 52. The power source 20 may include an input/output (I/O) 50 for outputting the electrical power on line 54 and for sending and receiving data communication signals on line 52. According to one embodiment, connector 18 may include a universal serial bus (USB) connector. However, it should be appreciated that the communication link 18 may be embodied in various wired and wireless connections. For example, communication link 18 may include wireless communication of the data, such as by BLUETOOTH® or local area network (LAN), and may also include wireless communication of the electrical power, such as by way of inductive coupling or RF transmission power.

Power source 20 is shown having a fluid consuming battery 22, such as a zinc air battery, which serves as the electrical power source to provide a battery output power, according to one embodiment. In the exemplary embodiment, the zinc air battery is an air-depolarized cell that uses zinc as the negative electrode active material and has an aqueous alkaline (e.g., KOH) electrolyte. The battery 22 includes an electrochemical cell that utilizes a fluid (such as oxygen or another gas) from outside the cell is an active material for one of the electrodes. The cell of battery 22 has a fluid consuming electrode, such as an oxygen reduction electrode. It should be appreciated that the battery 22 may contain an air-depolarized cell, an air-assisted cell or a fuel cell, and the cell and battery may have other shapes (such as button, cylindrical, and square shapes) and sizes, according to various embodiments.

The power source 20 also includes a fluid manager 24 that operates as a fluid regulating system, or fluid manager, for adjusting the rate of passage of fluid to the fluid consuming electrode (e.g., the air electrode in air-depolarized and air-assisted cells or oxygen or other gases in fuel cells) of battery 22 to provide a sufficient amount of fluid from outside the battery cell for discharge of the cell at high rate or high power, while minimizing entry of fluid into the fluid consuming electrode and water gain or loss into and from the cell during periods of low rate or no discharge. As used herein, unless otherwise indicated, the term “fluid” refers to fluid that can be consumed by the fluid consuming electrode of a fluid consuming cell in the production of electrical energy by the cell. The present invention is exemplified below by air-depolarized cells with oxygen reduction electrodes, but the invention can more generally be used in fluid consuming cells having other types of fluid consuming electrodes, such as fuel cells. Fuel cells can use a variety of gases from outside of the cell housing as the active material of one or both of the cell electrodes.

The fluid manager 24 regulates the flow of fluid to the fluid consuming electrode of the fluid consuming battery 22. For example, in an air-depolarized cell, an air manager may be disposed on the inside or outside of a housing 55 of battery 22 and on the air side of the oxygen reduction electrode (i.e., on, or a part of, the surface of the oxygen reduction electrode that is accessible to air from outside of the battery housing). The fluid manager 24 can include one or more valves as are known in the art. The fluid manager 24 can be an active fluid manager or a passive fluid manager. An active fluid manager includes a fluid mover, such as a fan or a pump to force fluid to flow toward or away from the fluid consuming battery. A passive fluid manager does not include a fluid mover.

The power source 20 can also include a valve position sensor 26 for sensing position of a valve in the fluid manager 24. In one embodiment, the valve position sensor 26 senses position of a sliding valve of the fluid manager 24 relative to the open and closed valve positions, and may provide intermediate positions between the fully open and closed positions. As shown in FIG. 4, the valve position sensor 26 may include a first sensor positioned to sense an open state of the fluid regulating system, and a second sensor for sensing a closed state of the fluid regulating system. A temperature sensor 28 can also be included in power source 20 for sensing temperature of the power source 20, particularly the battery 22. Further, a battery current sensor 32 can be provided in power source 20 for sensing the electric current output of the battery 22. The output voltage (VO) of the battery 22 may readily be sensed on line 33 by controller 36. It should be appreciated that the temperature sensor 28 and battery current sensor 32 may be integrated into or onto the battery 22 or may be separate and distinct therefrom.

The power source 20 can also include power conversion circuitry 30 for controlling the electrical power supplied to the device 10. Power conversion circuitry 30 may include a DC-to-DC converter for converting the DC voltage battery output power from the battery 22 at one voltage level to a DC voltage power source output at another voltage level to meet the requirements for charging and/or operating the device 10. In addition or alternately, power conversion circuitry 30 may regulate the amount of current supplied to the device 10. The DC-to-DC converter may operate at various levels, such as to include an “off” setting, a “sleep” setting, “low” and “high” settings and intermediate settings between the high and low settings based on control circuitry as described herein. The DC-to-DC converter voltage output levels may be discrete or continuous in nature and can be controlled in a variety of manners to provide a constant current, a constant voltage, a pulse width modulated (PWM) signal, a pulse frequency modulated (PFM) signal, and other forms of signals necessary to meet the charging and/or operating requirements of the device 10. The power conversion circuitry 30 may include a feedback signal output to the controller 36 to indicate the status of the output power, such as a signal indicating that the power level is acceptable.

The power source 20 can include the controller 36 which may include a microprocessor 38 or other control circuitry. The controller 36 can also employ a memory 40 which includes any of a number of logic routines stored therein, including a fluid (e.g., air) manager logic routine 42 and a power conversion recharging logic routine 44 for example. Additionally, the memory 40 may include communication logic 46 for controlling communication of data and transmission of electrical power between the device 10 and the power source 20. It should be appreciated that the memory 40 may employ random access memory (RAM), read-only memory (ROM), electrically erasable programmable read-only memory (EEPROM), flash memory, and other memory storage medium for storing logic and data. It should also be appreciated that the controller 36 can advantageously control the operation of the fluid manager 24, the power conversion circuitry 30 or both so as to provide an efficient and effective supply of electrical power to the device 10. Additionally, controller 36 can communicate with the device 10 to send and receive data. The controller 36 may receive data information from the device 10 including data defining device criteria of the device, and send data information to the device 10. Controller 36 may command the fluid manager 24 to operate, such as by opening and closing the valve, turning an air mover on or off, or otherwise operating. Controller 36 may receive feedback signals from the fluid manager 24, such as a signal indicating that operation or actuation of the fluid manager 24 is in control. Controller 36 may receive data information relating to the battery 22, including voltage, current and rate of change of the voltage and current. The controller 36 may provide command values to the power conversion circuitry 30 to set the output voltage and/or output current and the operation level, such as high, low, sleep or off, according to one embodiment. The controller 36 may receive information from the power conversion circuitry 30 such as an indication that the operation of circuitry 30 is acceptable.

The controller 36 can control operation of the fluid manager 24 based at least in part on the device criteria. The device criteria include at least one predetermined energy requirement estimate. An energy requirement estimate is an estimate of the amount of energy needed over time for the device to perform an operating event (a task or sequence of tasks) and is based on one or more electrical parameters, such as power, current and voltage, over a period of time during which the operating event is expected to take place. For example, FIG. 11 shows a power profile for an operating event over a period of time, with power on the y-axis and time on the x-axis. The power profile includes periodic peak power pulses 302 with a relatively low background power level 304 between the pulses 302. The average power 306 is only slightly higher than the background power 304 because of the short duration of the pulses 302. In one embodiment the operating event can include a series of 1 msec. pulses at 5 volts and 1 amp (5 Watts), each followed by 10 seconds at 5 volts and 10 mamps (50 milliwatts), for a time weighted average of 505 milliwatt-seconds.

For the operating event illustrated in FIG. 11, if the controller 36 commanded the fluid manager 24 to open and close a valve based solely on instantaneous electrical measurements or calculations (e.g., electrical load), the valve might be opened and closed at and following each pulse, even though there might be sufficient fluid within a plenum inside the fluid manager 24 and/or the battery 22 to provide the required energy. This would unnecessarily consume energy and reduce the remaining discharge capacity of the battery 22.

The present invention overcomes this problem by controlling the operation of the fluid manager 24 based on device criteria that include a predetermined energy requirement estimate that takes into account the profile of electrical requirements over time rather than very brief, transient or instantaneous requirements. For example, a mobile telephone in a standby mode can have a low background power requirement while waiting to receive calls and also periodically transmit a brief signal. A power profile for such an operating event could be similar to that shown in FIG. 11. The energy requirement estimate might be the total energy required, as calculated from the magnitude of the background power required, the magnitude, duration and frequency of the peak power pulses, and the duration of time in the standby mode. Upon receipt of the predetermined energy requirement from the device 10, the controller 36 can command the fluid manager 24 to open the valve at predetermined time intervals, for predetermined durations and/or by predetermined amounts that will provide sufficient fluid over a period of time. The volumes of any fluid plenums that are available to the battery 22 can also be factored in to further minimize the total energy required to operate the fluid manager 24. Thus the energy requirement estimate is based not on instantaneous parameters such as device load, but on known requirements (e.g., power) for one or operating events over time (i.e., energy), thereby minimizing the total energy required to operate the fluid manager 24.

The predetermined energy requirement estimate can be determined for a period of time that exceeds the minimum time for the fluid manager 24 to respond and change the rate of flow of fluid to the fluid consuming battery 22. This can advantageously reduce the frequency of operation of the fluid manager 24.

The invention is advantageous not only when the electrical requirements (e.g., voltage, current and/or power) vary substantially during an operating event, as described above with reference to FIG. 11, but also when there are substantial changes in the electrical requirements from one operating event to another in a sequence of operating events. The fluid manager can be controlled based on the combined predetermined energy estimates for the sequence of operating events.

In some embodiments it may be desirable to group operating events with similar predetermined energy requirement (i.e., within an established range) and control the operation of the fluid manager 24 in the same manner for each of the operating events within the group.

The device criteria, in addition to at least one predetermined energy requirement estimate, can include other device data or information, such as device temperature and condition of the device's rechargeable battery 12, and operation of the fluid manager 24 based on the predetermined energy requirement estimate can be modified or adjusted accordingly. Control of the fluid manager 24 can also be based in part on one or more other factors, such as the ambient temperature and the condition of the battery 22 (e.g., open circuit voltage, closed circuit voltage, current, resistance, capacity used and capacity remaining), and the fluid manager 24 can be further controlled to limit the frequency of operation based on the time the valve has been open or the rate of change in the voltage of battery 22, as described in further detail below.

The power source 20 can also include a user interface 34. The user interface 34 may include a display, such as a touch screen display for outputting commands and data and allowing input from a user. Additionally, user interface 34 may include a keypad or other push buttons for inputting data, and may include other outputs such as audio.

The power source 20 may be configured in various shapes and sizes in a housing as should be evident to those skilled in the art. For example, the housing may include top, bottom, rear, left and right side walls that form an enclosure for enclosing the various components. The power source 20 may be a separate and distinct assembly that is connectable to the device 10, according to the embodiment depicted in FIG. 1. According to another embodiment, the power source 20 may be integrated into a structure that is connected to or includes the device 10.

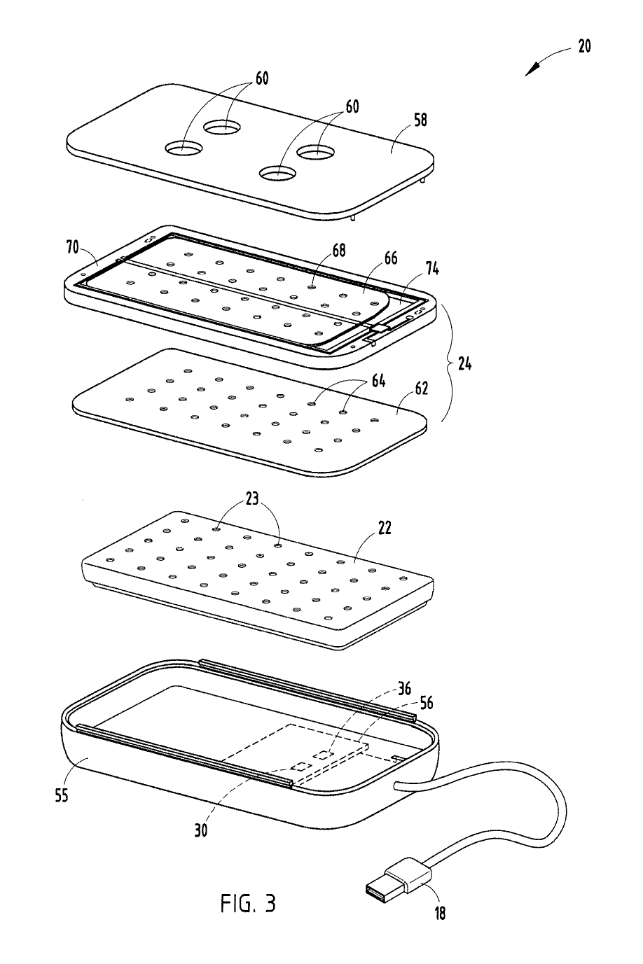

The device 10 receives power for operating the device and/or recharging the internal battery 12. The device 10 can also communicate with the controller 36 to provide criteria including data information about the operating modes, internal battery 12 state of charge (SOC), requests for external power, and parameters indicating the voltage and/or current levels requested from the power source 20. The device 10 can receive information from the power source 20 including acknowledgements of transmitted information from the controller 36, charger system operating mode, battery 22 capacity, current, voltage, and maximum power, and other information. The device 10 performs intended functions as should be evident to those in the art. By knowing the device 10 requirements in real time, the fluid manager 24 and power conversion circuitry 30 may be operated in a coordinated manner to maximize the benefit to the end user to achieve optimal energy from the battery 22 and realize optimal use of the device 10. The power conversion circuitry 30 and controller 36 are shown in FIG. 3 mounted on a substrate 56, such as a printed circuit board. It should be appreciated that other circuit components may be provided on substrate 56.

The fluid manager 24 is shown and described herein as a sliding valve, according to one embodiment, which selectively supplies fluid (e.g., air) to the battery 22. However, it should be appreciated that the fluid manager 24 may be configured according to other embodiments as an alternatively configured valve, actuator, louver, fan, pump, other fluid manager control device, or combination thereof. The fluid manager 24 may be discretely actuated to open and closed positions, may be partially open or have a varying fan or pump speed, according to various embodiments, based on operation controlled by the controller 36. The controller may control the fluid manager 24 by use of a pulse width modulated signal, a pulse frequency modulated signal, a constant voltage, a constant current, a linear or non-linear signal, or other known control means. The fluid manager 24 may provide a feedback output signal to the controller 36 indicating the status of the fluid manager 24, such as the fluid manager is in control in a certain position, or other fluid manager acknowledgement signals.

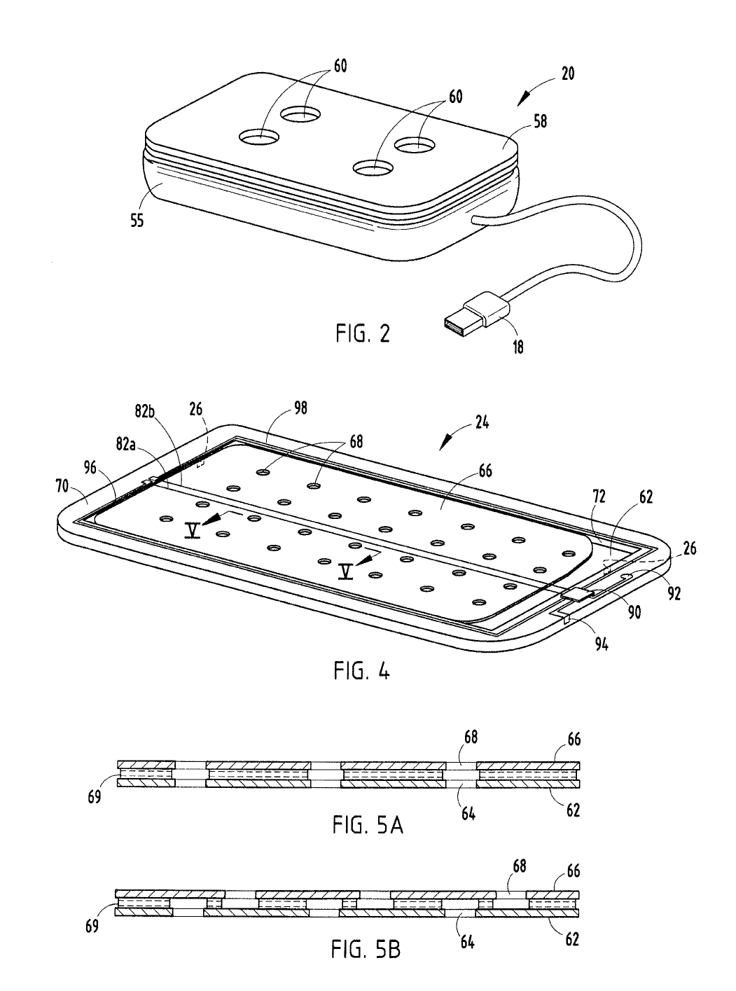

Referring to FIGS. 2 and 3, the power source 20 is further illustrated, according to one embodiment, having a housing 55 with a bottom, four side walls, and a removable cover 58 defining an enclosure containing the various components including the battery 22, fluid manager 24 and control circuitry. The cover 58 includes a plurality of openings 60 for allowing fluid to pass from the outside environment through the fluid manager 24 when in an open position and into the fluid consuming battery 22 via holes (apertures) 23. Accordingly, the power source 20 is easily portable and may be transported to a device and connected thereto by way of connector 18 to provide controlled battery power for operating and/or charging the device 10.

The fluid manager 24 is shown in FIGS. 3-5B according to one embodiment as a valve that includes a fixed first plate 62 having a plurality of apertures 64, and a movable second plate 66 including a plurality of apertures 68 that correspond in size, shape, number and position to apertures 64 formed in the first plate 62. The size, shape, number and position of apertures 64 and 68 may be optimized to provide the desired volume and distribution of fluid applied to the fluid consuming electrode of the battery 22.

The fluid manager 24 can further include a chassis 70 having an annular body portion 72 with an opening 74 in which the movable second plate 66 is disposed. Opening 74 may be shaped and sized to contact the elongated side edges of plate 66 while providing access space at the shorter side of plate 66, such that plate 66 may be slid linearly along an axis in parallel with its longest dimension. As shown in FIGS. 5A and 5B, the apertures 68 of second plate 66 may be moved into and out of alignment with apertures 64 of first plate 62 to thereby open and close the valve. The chassis 70 guides and can retain the movable second plate 66 adjacent to the fixed first plate. In addition, a lubricating layer 69 a fluid or a low friction material such as a film or coating of TEFLON® may be disposed between plates 62 and 66 to enable the second plate 66 to more readily slide along the surface of plate 62. Thus, the lubricating layer 69 enables the valve to be opened and closed requiring less force by the actuator. Additionally, because it may be difficult to get the surfaces of plates 62 and 66 to be sufficiently smooth so as to provide a good seal, the lubricating layer 69 may comprise an oil such as a silicon oil to enhance the sealing characteristic of the valve. It should be appreciated that one of the plates may be made of a magnetic material or other mechanism for holding plate 66 firmly against plate 62.

Referring to FIG. 4, the fluid manager 24 is shown including an actuator to actuate the valve. According to one embodiment, the actuator may include a control circuit 90, such as an application specific integrated circuit (ASIC) mounted to the surface of the chassis 70 and one or more shaped memory alloy (SMA) components for actuating the moving plate 66 between open and closed positions. The one or more SMA components may include a first SMA wire 82a and a second SMA wire 82b secured at opposite ends of the chassis 70 and electrically coupled to circuit traces 96 and 98. By supplying a control signal that passes a current through the SMA wires 82a and 82b, the control circuit 90 may cause the SMA wires to heat up, which causes the SMA wires to expand or constrict to a particular length. This in turn causes the SMA wires to pull the moving plate 66 in one direction or the opposite direction and thus causes plate 66 to slide in and out of an open or closed position so as to selectively allow fluid (e.g., air) to pass into the interior of the battery 22 when the plate 66 is in an open position.

SMA wires 82a and 82b may be made with any conventional shape memory alloy. A shape memory alloy is an alloy that can be deformed at one temperature but when heated or cooled returns to its previous shape. This property results from a solid phase transformation, between the Martensite and Austenite phases. Preferred shape memory alloys have a two-way shape memory; i.e., the transformation is reversible, upon both heating and cooling. Examples of shape memory alloys include nickel-titanium, nickel-titanium-copper, copper-zinc-aluminum and copper-aluminum-nickel alloys, with nickel-titanium and nickel-titanium-copper being preferred. The use of nickel-titanium-copper (e.g., with about 5-10 weight percent copper) can be advantageous for actuators that may be operated many times because of its resistance to fatigue. Manufacturers of nickel-titanium and other shape memory alloys include Specialty Metals, Shaped Memory Alloy Division (New Hartford, N.Y., USA), Memry Corporation (Bethel, Conn., USA), and Dynalloy, Inc. (Mesa, Calif., USA).

Contact terminals 92 and 94 are provided on the chassis 70 for connection to positive and negative terminals of the battery 22 so as to provide electrical current to actuate the SMA wires 82a and 82b. Additionally, it should be appreciated that the control circuit 90 may be in communication with controller 36, according to one embodiment. Ultimately, the control circuit 90 may be integrated into the controller 36 and may include the logic for controlling the actuation of the fluid manager 24 between open and closed positions. The SMA wires 82a and 82b may be configured in any of a number of shapes and locations so as to provide actuation of the moving plate 66 between the open and closed positions. While an SMA actuator is shown and described herein for controlling a sliding valve, it should be appreciated that other actuators and other types of valves may be employed as the fluid manager 24 for selectively controlling fluid entry to the battery 22.

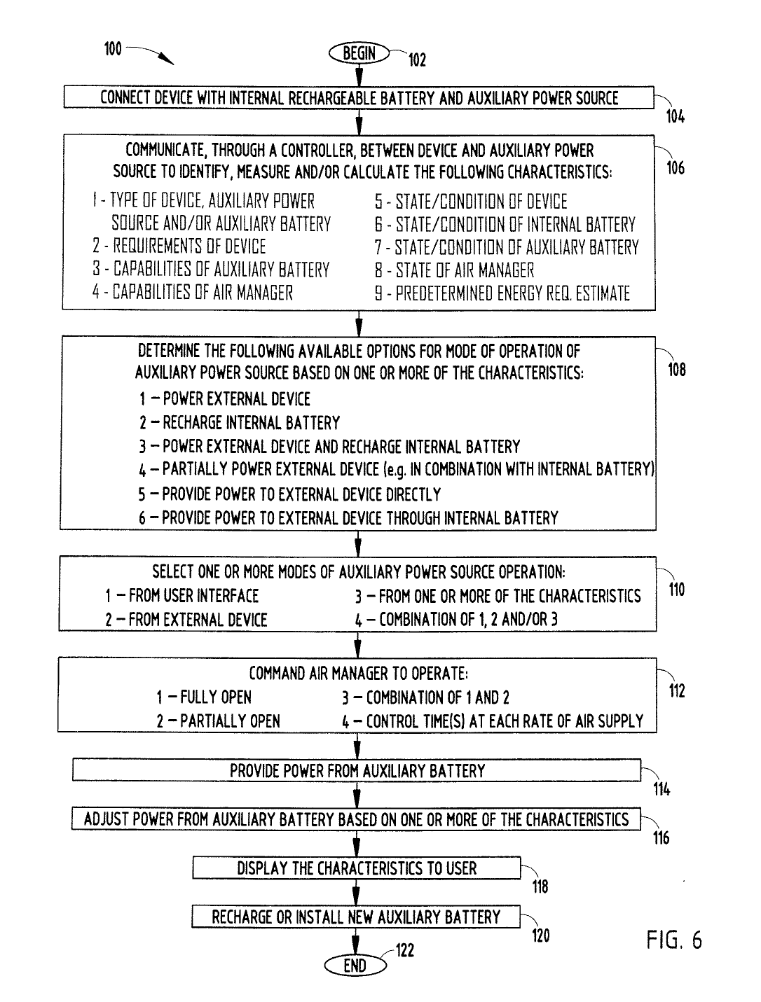

Referring to FIG. 6, a method 100 of operating the power source 20 to supply power to operate a device 10 and/or charge the internal rechargeable battery 12 of device 10 is illustrated according to one embodiment. The method 100 begins at step 102 and proceeds to step 104 to connect a device with an internal rechargeable battery and the auxiliary power source. This may include inserting the rechargeable battery into a battery compartment in the device and making a power and data connection between the power source and the device. Next, in step 106, the device and the auxiliary power source communicate data through a controller, such as controller 36 of power source 20, to identify, measure and/or calculate one or more criteria or characteristics. The one or more criteria or characteristics may include one or more of the following: (1) the type of device, the type of auxiliary power source and/or the type of auxiliary (fluid consuming) battery; (2) requirements of the device; (3) capabilities of the auxiliary battery; (4) capabilities of the fluid manager; (5) state/condition of the device; (6) state/condition of the internal battery; (7) state/condition of the auxiliary battery; (8) state of the fluid manager; and (9) a predetermined energy requirement estimate.

Next, method 100 proceeds to step 108 to determine one or more available options for mode of operation of the auxiliary power source based on the one or more aforementioned characteristics. Included in the one or more operations are the following options: (1) power the device; (2) recharge the internal battery; (3) power the device and recharge internal battery; (4) partially power the device (e.g., in combination with internal battery); (5) provide power to the device directly; and (6) provide power to the device through the internal battery.

Method 100 then proceeds to step 110 to select one or more modes of the auxiliary power source operation from the following selections: (1) user interface, (2) device, (3) one or more of the characteristics and (4) a combination of the aforementioned selections 1-3. Method 100 then commands the fluid manager to operate either fully open, partially open, a combination of fully and partially open, or to control times at each rate of fluid supply in step 112. The power is then provided from the auxiliary battery in step 114 based on the fluid supplied by the fluid manager. In step 116, the method adjusts the power from the auxiliary battery based on the one or more characteristics. This may include converting the auxiliary battery power output to a desired power supply output by using power conversion circuitry. Method 100 then displays the characteristics to the user in step 118. In step 120, method 100 may recharge or install a new auxiliary battery in the power source, when needed, and ends at step 122.

It should be appreciated that the power conversion circuitry 30 may include known circuitry for converting the battery output from one level to another. According to one embodiment, the power conversion circuitry 30 may convert the voltage output of the battery 22 from one voltage to a second different voltage. According to another embodiment, the power conversion circuitry 30 may convert the current output of the battery from one current level to another current level.

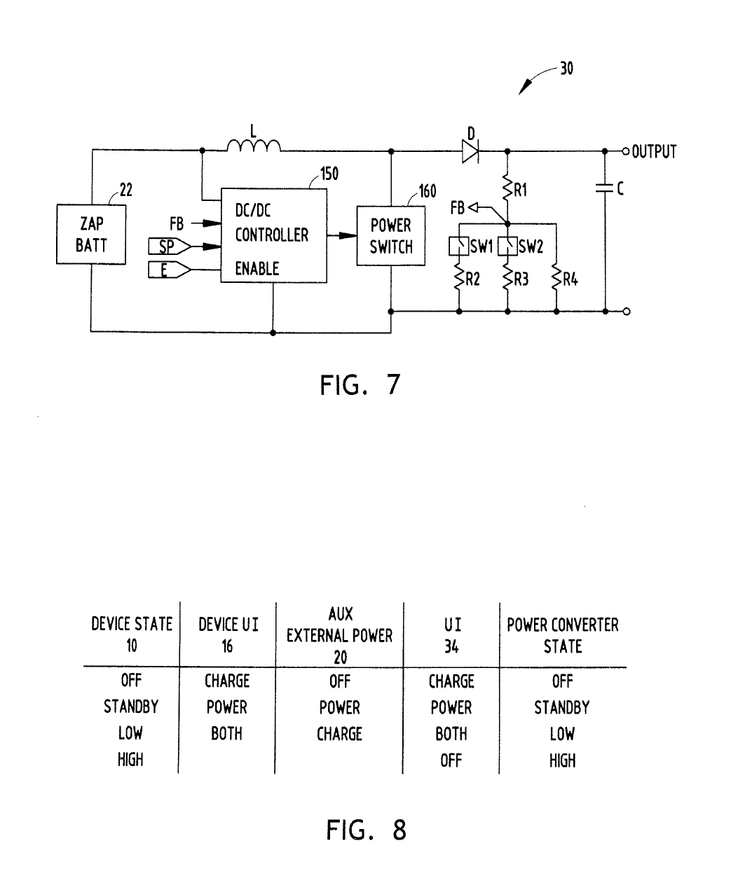

The power conversion circuitry 30 is illustrated in FIG. 7, according to one embodiment. The power conversion circuitry 30 is shown connected to the fluid consuming battery 20 to provide a controlled output voltage at the output. The power conversion circuitry 30 includes a DC/DC converter controller 150 coupled to a power switch 160 which turns the conversion circuitry on and off An inductor L and diode D are connected between the DC/DC converter controller 150 and the output to provide a stable voltage output. A capacitor C is connected between the output terminals to provide filtering. A resistor divider network is provided made up of resistors R1, R2, R3 and R4. Additionally, resistors R2 and R3 are coupled to switches SW1 and SW2, respectively. Switches SW1 and SW2 may be turned on and of to provide different levels of resistance across the output terminals, such that a plurality of the combinations of resistance may be achieved to adjust the voltage output as desired. The switches SW1 and SW2 may be controlled by the DC/DC converter controller 150 and may be controlled by the power conversion control logic executed by the controller 150 or another controller. Accordingly, by switching in resistor R2 alone, or resistor R3 alone, bo both resistors R2 and R3, or neither of resistors R2 and R3, the resistance across the output terminals may be changed to change the output voltage. Additionally, the DC/DC converter controller 150 has a feedback signal FB taken at the node between resistors $1 and R4, and includes a set point input SP and enable input E. The set point value SP may be modified by way of a control routine to adjust the power conversion output. It should further be appreciated that while a voltage power conversion is illustrated in the current example of the power conversion circuitry 30, that other forms of power conversion may be achieved, such as a conversion of the electrical current.

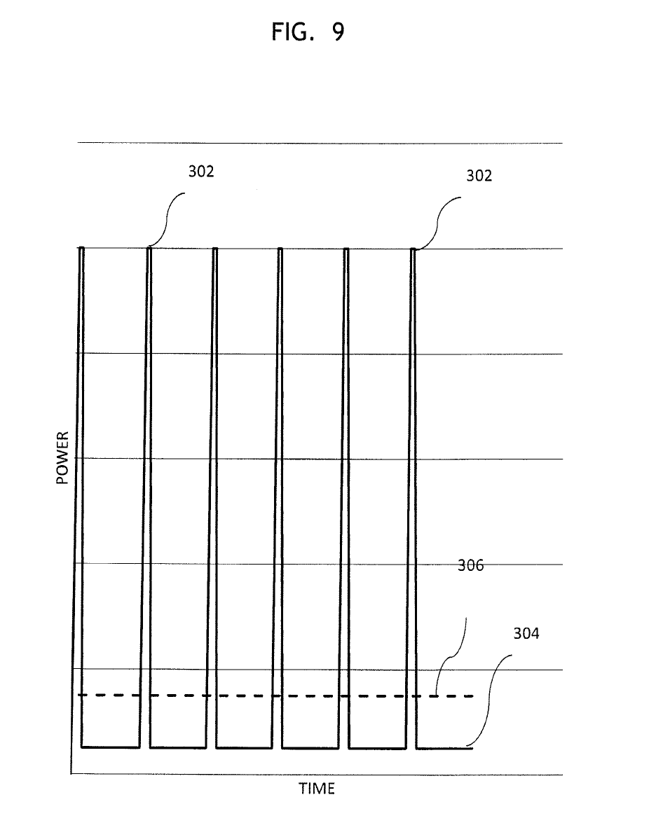

Referring to FIG. 8, the various available states of the device 10, the user input 16, the auxiliary power source 20, the user interface 34, and the power conversion 30 are illustrated, according to one example. It should be appreciated that the device 10 include various states, such as an off state, a standby state, a low state and a high state. The user interface 16 provided in the device 10 may allow a user to select a charge state, a power stat, or both the charge and power states. The power source 20 may include an off state, a power state, and a charge state. The user interface 34 provided with the power source 20 may be used to select the charge state, the power state, both the charge and power state, or an off state. The power conversion circuitry 30 may be set to an off state, a standby state, a low state, or a high state. It should be appreciated that while a plurality of states of the various devices is illustrated in FIG. 8, that any of a number of states may be provided depending upon the device and the criteria for operating and/or charging the device.

### Example 1

An example of a device that can use a power source according to the present invention is a mobile telephone. Table 1 lists possible operating events, including hypothetical power requirements and time profiles from which predetermined energy requirement estimates can be calculated. Controlling the operation of the fluid manager based on predetermined energy requirement estimates is of particular advantage when there are significant changes in the device's power requirements over a period of time, such as changes during an operating event and differences from one operating event to another in a sequence of operating events.

In one exemplary situation, for the Transmit-standby operating event (D), the predetermined energy requirement could be based on the time weighted average of less than 10 mW times an indefinite period of time, and the fluid manager valve could be partially opened by a sufficient amount to continuously provide 10 mW of power, or the valve could be fully opened for sufficient time to replenish the amount of fluid in a plenum on the battery side of the valve to sustain the operating event until the next opening of the valve.

In another exemplary situation, for the Ring operating event, the valve might open initially for a period of time sufficient to provide enough fluid for up to 10 rings, or 2000 mW-seconds. The valve might then be closed if no other operating events are initiated, or closing of the valve might be controlled based on the predetermined energy requirement estimate(s) of another operating event(s) that follow (e.g., operating events A, E and J).

TABLE 1

| Operating Event | | Power | Time Profile |
|---|---|---|---|
| A | Backlight on | 100 mW | continuous |
| B | Ring | 200 mW | 1 sec. on, 1 sec. off |
| | | | (100 mW twa*) |
| C | Vibrate | 200 mW | 1 sec. on, 1 sec. off |
| | | | (100 mW twa*) |
| D | Transmit - standby | 500 mW | pulse (<10 mW twa*) |
| E | Transmit - call | 500 mW | Continuous |
| F | Speaker on | 50 mW | Continuous |
| G | Decode video | 75 mW | Continuous |
| H | Video processor on | 50 mW | Continuous |
| I | Receive - standby | 50 mW | pulse (<5 mW twa*) |
| J | Receive - call or | 50 mW | continuous |
| | data | | |
| K | Internal processing | 75 mW | continuous |

*twa = time weighted average

The operating events in Table 1 can be combined in various ways according to operating modes, such as Standby, Talk (initiate a voice call), Incoming Call (prepare to receive a call), and Streaming Video (watch an incoming streaming video). Table 2 shows operating events that may be part of each of these operating modes. Those operating events in parentheses may be optional, based on whether or not they are selected by the user, or they could be delayed if there is insufficient power available initially. Predetermined energy requirement estimates can be established for individual operating events separately, for combinations of operating events, or for entire operating modes.

TABLE 2

| | | Incoming | Streaming |
|---|---|---|---|
| Standby | Talk | Call | Video |
| Mode | Mode | Mode | Mode |
| D | E | (A) | A |
| I | F | (B) | D |
| | J | (C) | J |
| | (A) | I | F |
| | | D | G |
| | | K | H |

For those operating events that do not have a continuous power time profile, unnecessary opening and closing of the air manager valve can be avoided by controlling the fluid manager operation based on the predetermined energy requirement estimate for that operating event rather than instantaneous frequent periodic measurements of the device, the device's internal battery or the power source's fluid consuming battery load. For example, for the Ring operating event (B) the valve might be opened near the start and closed shortly after each ring if the valve was controlled based on measured loads, even though there might be sufficient air available in an air plenum on the inside of the fluid manager to operate for multiple rings. By controlling the fluid manager based on the predetermined energy requirement estimate for the Ring operating event, the valve might be opened and closed only once, or possible not at all. Alternatively, operation of the fluid manager might be controlled based on the anticipated requirements of an entire operating mode (Incoming Call Mode in this case), including the operating event (the Ring operating event in this case), rather than just the single operating event portion of that mode, to more efficiently meet the power requirements of the device with minimal consumption of the fluid consuming battery's discharge capacity.

In some operating modes (e.g., Standby and Streaming Video in Table 2), all of the operating events in that mode may occur simultaneously, but in others (e.g., Talk and Incoming Call) some operating events may occur periodically or only if initiated by the device user. Within an operating mode, a predetermined energy requirement estimate can be established for some or all operating events within that operating mode to maximize efficient control of the fluid manager.

Initiation of operating events can be delayed as a result of communication between the device and the power source to allow sufficient time for the fluid manager to be able to provide fluid to the fluid consuming battery at a sufficient rate to sustain all operating events. For example, in the Incoming Call Mode in Table 2, any of operating events A, B and C could be delayed briefly upon initiation of that operating mode until the output power capability of the fluid consuming battery is sufficient for all of the operating events needed.

### Example 2

Another example of a device that can use a power source according to the present invention is an MP3 player with a hard drive. Table 3 lists possible operating events, including hypothetical power requirements and time profiles from which predetermined energy requirement estimates can be calculated.

TABLE 3

| Operating Event | | Power | Time Profile |
|---|---|---|---|
| A | Backlight on | 100 mW | continuous |
| B | Headphone amplifier on | 30 mW | continuous |
| C | Read from Memory | 250 mW | 250 mW for 10 seconds |
| | | | every 4 minutes |
| | | | (once per song) |
| | | | (twa about 10 mW) |
| D | Internal charge control | 25 mW | continuous |
| E | Voice recording | 50 mW | continuous |
| F | Data synchronize | 15 mW | continuous |
| G | WiFi | 150 mW | continuous |

*twa = time weighted average

The operating events in Table 3 can be combined in various ways according to operating modes, such as Play, Synchronize, Charge and Standby modes. Table 4 shows operating events that may be part of each of these operating modes. Those operating events in parentheses may be optional, based on whether or not they are selected by the user, or they could be delayed if there is insufficient power available initially. Predetermined energy requirement estimates can be established for individual operating events separately, for combinations of operating events, or for entire operating modes.

TABLE 4

| Play | Synchronize | Charge | Standby |
|---|---|---|---|
| Mode | Mode | Mode | Mode |
| (A) | (A) | (A) | D |
| B | (D) | D | |
| C | F | (F) | |
| | (G) | (G) | |

In this example the Play mode the hard drive reads a song from memory, requiring 250 mW for an average of 10 seconds. If the next song is not read until the first song has been played (4 minutes), the time weighted average would be about 10 mW for operating event C for example. The frequency of opening and closing the air manager can be reduced with the present invention due to the low average power requirement for operating event C compared to the relatively short duration of peak power required to read a song from memory.

### Example 3

Another example of a device that can use a power source according to the present invention is a light. Table 5 lists possible operating events, including hypothetical power requirements and time profiles from which predetermined energy requirement estimates can be calculated.

TABLE 5

| Operating Event | | Power | Time Profile |
|---|---|---|---|
| A | Off | 0 | |
| B | Standby | <1 mW | continuous |
| C | “Find Me” | 60 mW | 25 msec/5 sec. (<1 mW twa*) |
| D | Low | 25% | continuous |
| E | Medium | 50% | continuous |
| F | High | 100% | continuous |
| G | Light 1 (white) | 1000 mW | continuous |
| H | Light 2 (red) | 100 mW | continuous |
| I | Light 3 (ultraviolet) | 300 mW | continuous |
| J | Blink | 100% | 1 sec. on, 1 sec. off (50% twa*) |

*twa = time weighted average

The operating events in Table 5 can be combined in various ways according to operating modes, such as Standard Illumination Mode, Signal Mode, Long Run Emergency mode. Table 6 shows operating events that may be part of each of these operating modes. Those operating events in parentheses may be optional, based on whether or not they are selected by the user, or they could be delayed if there is insufficient power available initially. Predetermined energy requirement estimates can be established for individual operating events separately, for combinations of operating events, or for entire operating modes.

TABLE 6

| | Standard | | Long Run |
|---|---|---|---|
| Standby | Illumination | Signal | Emergency |
| Mode | Mode | Mode | Mode |
| B | D or E or F | H or I and/or J | D |
| C | G | | G or H or I |
| | | | (J) |

In this example, some operating events (e.g., G, H, I and J) can be modified by others (e.g., D, E and F) to provide low, medium or high power operation of Light 1, Light 2 or Light 3, either continuously on or blinking. For instance, in the Standard Illumination Mode, a predetermined energy requirement estimate for the use of Light 1 on Medium power could be the product of G (1000 mW continuous) and E (50% continuous), or 500 mW continuous. In the Long Run Emergency Mode the predetermined energy requirement estimate for the use of Light 2 on Low power Blinking could be the product of H (100 mW continuous), D (25% continuous) and J (100% 1 sec. on and 1 sec. off) or a time weighted average of 12.5 mW.

While the invention has been described in detail herein in accordance with certain preferred embodiments thereof, many modifications and changes therein may be affected by those skilled in the art without departing from the spirit of the invention. Accordingly, it is our intent to be limited only by the scope of the appending claims and not by way of the details and instrumentalities describing the embodiments shown herein.

What is claimed is:

1. A power source comprising:
a fluid consuming battery comprising a fluid consuming electrode, said fluid consuming battery supplying a battery output power;
a fluid manager capable of controlling a rate of fluid supplied to the fluid consuming battery;
a communication link comprising a bidirectional data communication path between the power source and a device, the communication link configured to receive data defining device criteria for at least one device operating event from the device and to provide data to the device;
a power output configured to receive the battery output power and supply a power source output to the device according to the device criteria; and
a controller configured to control operation of the air manager based on the device criteria;
wherein the device criteria for the at least one device operating event comprise at least one predetermined energy requirement estimate; and
wherein the at least one device operating event is delayed as a result of the communication between the power source and the device.

2. The power source as defined in claim 1, wherein the predetermined energy requirement is estimated over a period of time that exceeds a minimum time required for the fluid manager to change the rate of fluid flow to the fluid consuming battery in response to a change in the device criteria.

3. The power source as defined in claim 1, wherein the device criteria comprise a plurality of operating events.

4. The power source as defined in claim 3, wherein at least two of the operating events have different predetermined energy requirement estimates.

5. The power source as defined in claim 4, wherein each predetermined energy requirement estimate corresponds to a single operating event.

6. The power source as defined in claim 1, wherein the operating events can be grouped such that within each group the predetermined energy requirement estimates are within a predetermined range, and the fluid manager can be controlled in the same manner for all operating events within the same group.

7. The power source as defined in claim 3, wherein at least two of the operating events occur in a sequence in an operating mode.

8. The power source as defined in claim 7, wherein the fluid manager can be controlled based on the combined predetermined energy requirement estimates for the sequence of operating events.

9. The power source as defined in claim 1, wherein the fluid manager can also be controlled based on a load.

10. The power source as defined in claim 1, wherein the fluid manager can also be controlled based on fluid consuming battery criteria.

11. The power source as defined in claim 10, wherein the fluid consuming battery criteria comprise at least one member of the group consisting of an open circuit voltage, a closed circuit voltage, a current, a resistance, a capacity used, a capacity remaining and a temperature.

12. The power source as defined in claim 1, wherein the device criteria further comprise a device temperature.

13. The power source as defined in claim 1, wherein the fluid manager comprises a valve for adjusting rate of passage of fluid into the fluid consuming electrode, and an actuator for operating the valve between at least open and closed positions, wherein the controller is configured to control the actuator to open and close the valve.

14. The power source as defined in claim 13, wherein the valve comprises at least one moving plate, wherein the actuator is capable of moving the at least one moving plate between open and closed positions to control fluid supplied to the fluid consuming electrode.

15. The power source as defined in claim 1, wherein the communication link comprises a USB cable.

16. The power source as defined in claim 1, wherein the communication link comprises a wireless communication.

17. The power source as defined in claim 1, wherein the communication link is configured to allow data communication with the device, such that the device is able to communicate data defining device criteria for supplying the power source output to the external device, and the controller is capable of controlling the fluid manager to achieve a desired battery output power.

18. The power source as defined in claim 17, wherein the power source further comprises power conversion circuitry configured to convert the battery output power to a power source output and the controller is further configured to control the power conversion circuitry to achieve a desired power source output.

19. The power source as defined in claim 17, wherein the communication link is configured to allow the exchange of operation and power needs between the device and the power source.

20. A method of supplying electrical power to an electronic device, the method comprising the steps of:
providing a fluid consuming battery comprising a fluid consuming electrode and a fluid manager;
coupling the fluid consuming battery to a device;
communicating data defining device criteria for at least one device operating event from the device to a controller associated with the fluid consuming battery for controlling a rate at which fluid is to be provided to the fluid consuming electrode, wherein the device criteria for the at least one device operating event comprise at least one predetermined energy requirement estimate;
communicating data from the power source to the device;
determining an amount of energy to be provided to the device over a period of time based on the device criteria;
determining the rate at which fluid is to be provided to the fluid consuming electrode for the fluid consuming battery to provide the amount of energy to be provided over the period of time;
controlling operation of the fluid manager to provide fluid to the fluid consuming electrode at the determined rate.
